(19) United States
(12) Patent Application Publication
(10) Pub. No.: US 2004/0056407 A1
(43) Pub. Date: Mar. 25, 2004

(54) Sheet handling mechanism

(76) Inventor: William H. Gunther, Mystic, CT (US)

Correspondence Address: WILLIAM COLLARD, COLLARD & ROE, P.C., 1077 NORTHERN BOULEVARD, ROSLYN, NY, 11576, US

(21) Appl. No.: 10/640,390

(22) Filed: Aug. 14, 2003

Related U.S. Application Data
(63) Continuation-in-part of application No. 10/252,140, filed on Sep. 23, 2002.

(51) Int. Cl. B42B 2/00

(52) U.S. Cl. 270/52.09

(57) ABSTRACT

A sheet handling mechanism having a printer assembly and a set stacker assembly having an elevator. The printer assembly prints sheets which are accumulated into a stack. The stack of sheets are deposited onto the elevator in an offset relationship to each other to form a group of offset stacks. A conveyor is provided for moving the group of stacks from the said elevator into an input unit and a buffer station is interposed between said printer assembly and the set stacker assembly for moving said stacks to said set stacker assembly.

### RELATED APPLICATION

This application is a continuation-in-part of pending patent application Ser. No. 10/252,140 filed Sep. 23, 2002.

### BACKGROUND

The present invention relates to a sheet handling mechanism and more particularly to a sheet handling mechanism in which printed sheets (printed either on a continuous web or printed individually) are accumulated in stacks and then fed to a stack receiving mechanism, such as an input unit or cassette.

In the printing industry, documents comprise a number of printed sheets. These sheets are printed either individually or are printed on a continuous web which is then split lengthwise, cut transversely and merged. The sheets are accumulated in stacks and the stacks are arranged in offset relationship to each other and deposited into a stack receiving input unit or cassette. When the cassette if full of offset stacks it is moved to a new location for other functions to be performed on the stacks. At least some of the operations described above are performed by mechanisms and/or methods described in U.S. Pat. Nos. 6,234,647; 6,324,442 and 6,192,295 (all of which are incorporated herein by reference).

It sometimes occurs that the printing mechanism prints sheets faster than the machine can stack the sheets and process the stacks so that printing of sheets must sometimes be stopped until the sheets that have already been printed are stacked and processed. This can cause substantial down time which is time consuming and expensive.

### OBJECTS

The present invention overcomes these drawbacks and has for one its objects the provision of an improved sheet handling mechanism in which the operation is continuous without interruption.

Another object of the present invention is the provision of an improved sheet handling mechanism in which the sheet stacking and stack processing operations do not interfere with the printing operation.

Another object of the present invention is the provision of an improved sheet handling mechanism in which the sheet printing and stack processing operations occur simultaneously without interruption.

Another object of the present invention is the provision of an improved sheet handling mechanism which is simple and inexpensive to use, maintain and manufacture.

Other and further objects of the invention will be obvious upon an understanding of the illustrative embodiment about to be described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is a schematic side plan view of a sheet handling mechanism made in accordance with the present invention.

FIG. 2 is a schematic top plan view of the sheet handling mechanism of FIG. 1 showing the various steps in the operation.

FIG. 3 is a schematic side plan view of another embodiment of the present invention.

FIG. 4 is a schematic top view of a portion of the sheet handling mechanism of FIG. 3.

FIG. 5 is a schematic side view of a variation of the embodiment shown in FIGS. 3 and 4.

FIG. 6 is a schematic top view of the variation shown in FIG. 5.

FIG. 7 is a schematic end view of the set stacker mechanism of FIGS. 3 to 6.

### DESCRIPTION

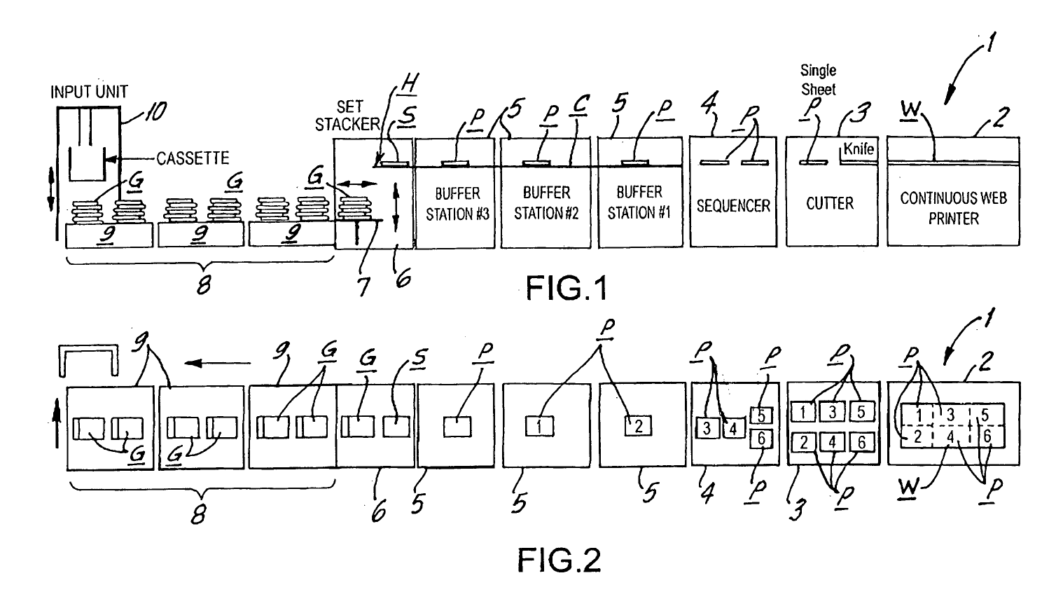

Referring to the drawings and more particularly to the embodiment of the invention shown in FIGS. 1 and 2, the sheet handling mechanism 1 of the present invention comprises a continuous web printer 2 which prints a web W of sheets or pages P with the sheets P printed in side-by-side relationship and one behind the other. The sheets P are numbered consecutively in a side-by-side relationship and one behind the other so that the printer 2 prints a complete document on the sheets P in the web W. In the preferred embodiment of the invention shown in FIGS. 1 and 2, the printer assembly 2 prints a document in which Page 2 is next to Page 1; Page 3 is behind Page 1; Page 4 is behind Page 2 and next to Page 3; Page 5 is behind Page 3; Page 6 is behind Page 4 and next to Page 5 and so forth in like manner until the last page of a complete document is printed. However, while in the preferred embodiment of FIGS. 1 and 2 the document is printed with the page 1 printed first and the last page printed last, it will be understood that it is within the purview of the present invention for the document to be printed in reverse order with the last page printed first and the first page printed last.

The continuous web W is then moved to a cutter assembly 3 having means (not shown) which slits the web W down the middle to separate the side-by-side sheets P and has means (not shown) which cuts the web W transversely to separate the sheets P that are one in back of another so that the sheets P now become single sheets P .

The sheets P are then moved to a sequencer assembly 4 which has means (not shown) for sequencing the sheets P one behind the other. In the preferred embodiment of the invention shown in FIGS. 1 and 2, the sequencer assembly 4 forms the sheets P with Page 1 in front followed by Pages 2, 3, 4, 5 and 6 following in that consecutive order. As shown more clearly in FIG. 2 of the drawings, assuming that a document contains six pages, Page 1 is first followed by Page 2, 3, 4, 5 and 6 so that a complete document is formed of six pages comprising Pages 1 to 6 in that order. However, it will be understood that it is within the purview of the present invention for the sheets to be sequenced in reverse order in which page 6 is first and page 1 is last.

Each sheet P is then passed to a plurality of buffer stations 5 which are comprised of conveyor mechanism C which has means (not shown) for moving the sheets P along from one buffer station 5 to the other until the sheets P reach a set stacker assembly 6. In the preferred embodiment of FIGS. 1 and 2, three buffer stations 5 are shown in the drawings. However, it will be understood that it is within the purview of the present invention to have more or less than the three buffer stations 5 shown in the drawings. While the sheets P are being moved along the buffer stations 5, the continuous web printer assembly 2, the cutter assembly 3 and the sequencer assembly 4 are still operating without interruption thereby permitting a continuous uninterrupted operation.

After leaving the buffer stations 5, the sheets P are placed in a set stacker assembly 6 comprising an elevator 7 which receives the sheets P from the last buffer station 5 and a stack holder H where the sheets P accumulated into a stack S. Means (not shown) are provided to deposit each stack S onto the elevator 7 and means (not shown) are also provided which causes the elevator 7 to move back and forth horizontally as each stack S is deposited thereon so that the stacks S of sheets P are deposited on the elevator 7 in offset relationship to each other. Assuming a document has six pages, Page 1 would be on the bottom and Page 6 would be on the top. However, it will be understood that this order of the Pages P may be reversed so that Page 6 is at the bottom and Page 1 is at the top. As each stack S is deposited in the elevator 7, means (not shown) lower the elevator at least one stack thickness to permit another stack S to be deposited on the previous stack S in order to accumulate a group G of stacks S on the elevator 7. This deposition of the stacks S on the elevator 7 in offset relationship to each other continues until the elevator 7 reaches the bottom and cannot receive any additional stacks S. When this occurs sensing means (not shown) are provided to activate means (not shown) to move the group G of stacks S from the elevator 7 onto a main conveyor assembly 8 which may comprise of a plurality of individual conveyors 9 or may be a single conveyor. At this point, the elevator 7 is empty and means (not shown) are provided to move the elevator up to its original position to receive more stacks S and to start forming another group G. While the elevator 7 is having its group G of the stacks removed or is moving upward, the buffer stations 5 will continue to receive sheets S which may start accumulating on the buffer stations 5 until the elevator 7 stops its upward movement and is ready to receive other stacks S.

The main conveyor assembly 8 has means (not shown) for moving the group G of offset stacks S along until they reach the end of the main conveyor assembly 8. A stack-receiving cassette or input unit 10 is provided to receive the group A of stacks S which, in the embodiment of FIGS. 1-2, is at right angles to the end of the main conveyor assembly 8. At this point, sensing means (not shown) are provided to activate an auxiliary conveyor (not shown) located at right angles to the main conveyor assembly 8 which moves the group G of stacks S into the cassette 10 as a group. This operation of moving groups G of stacks S into the cassette 10 continues until the cassette 10 is full, at which time the cassette 10 is removed and an empty cassette 10 is moved in position to replace it.

Since removal and replacement of the cassette 10 at the end of the main conveyor assembly 8 is a very quick operation (usually on the order of a few minutes or less) the other mechanisms and assemblies can continue to operate without interruption. Each of the conveyors 9 will receive and move groups G of stacks S until a group G reaches the input unit 10. It will be seen that because the stacks S move along the buffer stations 5 before being deposited in the set stacker assembly 6 the groups G of stacks S move along the conveyors 9 and into the cassette 10. The conveyors 9 are operating under instructions from a controller to receive groups G of stacks S from the set stacker assembly 6 and to move the groups G into the cassette 10 at the same time that the printer assembly 2, the cutter assembly 3 and sequencer assembly 4 are continuously operating without interruption to continuously print sheets P, form stacks S and groups G. Even when the full cassette 10 is removed by an operator and replaced with an empty one, the group G of stacks and the stacks S continue to be formed and moved without interruption.

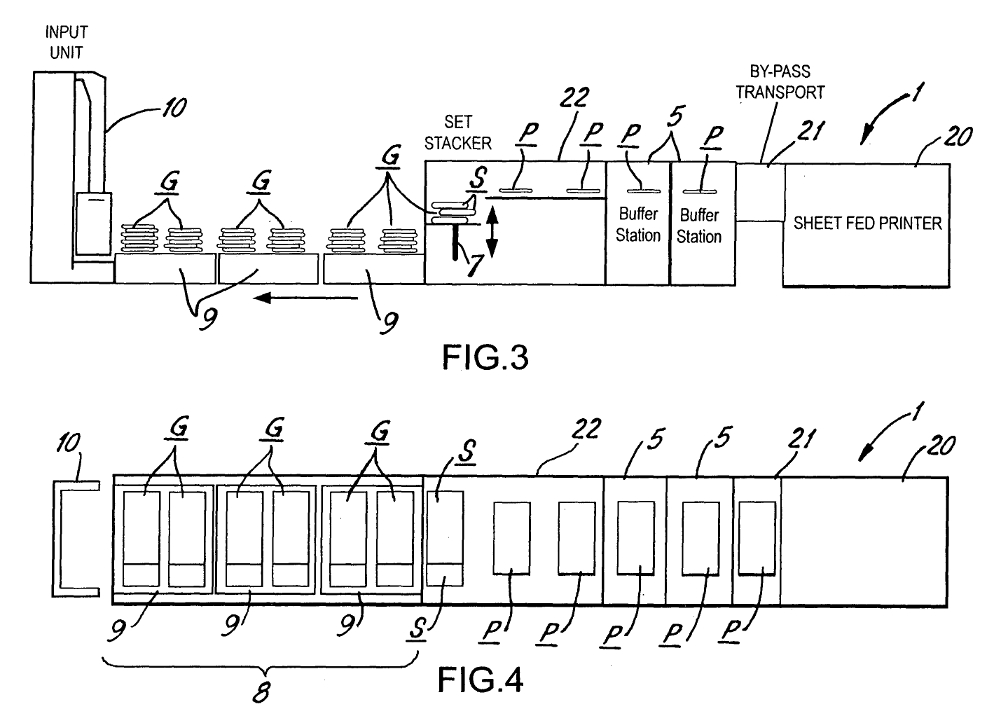

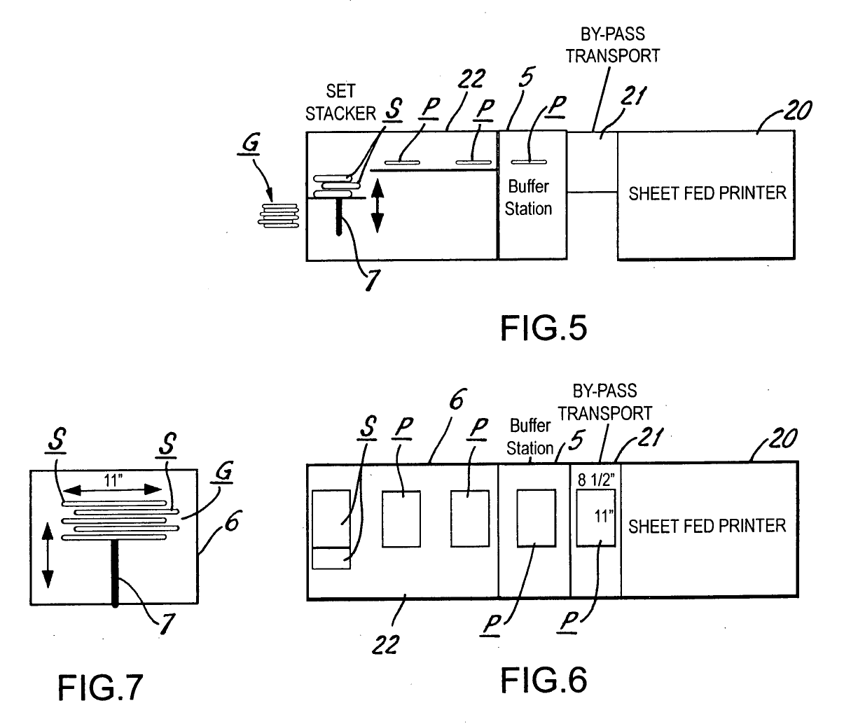

Referring to the embodiment of the invention shown in FIG. 3 to 7, the same reference numerals will be used that were used for the same structural elements in the FIGS. 1-2 embodiment and the operation of the structural elements in the FIGS. 3-7 embodiment will be the same as the operation of the same elements in the FIG. 1-2 embodiment. A sheet printer assembly 20 has means (not shown) for printing single sheets or pages P of a document. The pages P of a document are printed in numerical order and are deposited in a by-pass transport assembly 21 which moves the sheets P to the buffer stations 5, two of which are shown in FIGS. 3-4 and one of which is shown in the variation of FIGS. 5-6. However, it will be understood that the number of buffer stations 5 may be varied without departing from the invention.

The buffer stations 5 pass the sheets P to a set stacker assembly 22 which accumulates the sheets into stacks S and deposits the stacks S onto an elevator 7 where they accumulate into a group G of sheets S. The elevator 7 moves back and forth as each stack S is deposited on it so that the stacks S are deposited on the elevator 7 in offset relationship to each other where they accumulate on the elevator 7 as a group G. In this FIGS. 3-7 embodiment, assuming a document has six pages, Page 1 is on the bottom of the stack S and Page 6 is at the top of the stack S. However, this order of the pages P may be reversed, if desired, so that Page 6 is at the bottom and Page 1 is at the top.

Likewise, in this 3-7 embodiment, while the set stacker assembly 6 is forming the stacks S from sheets P and depositing the stacks S on the elevator 7 to form a group G of offset stacks S, the printer assembly 20, the by-pass transport assembly 21, and the buffer stations 5 are continuously operating without interruption. As each stack S is deposited on the elevator 7, the elevator 7 is lowered at least one stack thickness in order to be in position to receive another stack S on top of the previously deposited stack S. This continues until the elevator 7 is at its lowermost position and cannot receive any additional stacks. When elevator 7 is full and in its lowered position, each group G of stacks S on the elevator 7 is then moved to the conveyor assembly 8 to empty the elevator. When the elevator 7 is empty it will rise to its upward position to receive more stacks S to form another group G of stacks S. The buffer stations 5 are receiving sheets S during the downward movement and emptying of the elevator 7 and some sheets S may start to accumulate on the buffer stations at this time. The groups G of offset stacks S continue to move on the conveyor assembly 8 until they reach a stack-receiving input unit or cassette 10 which, in this FIGS. 3-7 embodiment, is in line with the conveyors 9 in the conveyor assembly 8 (rather than at right angles to it as in the FIGS. 1-2 embodiment). At this point, the conveyor assembly 8 moves the group G of stacks S into the cassette 10. This operation continues until the cassette 10 is full, at which time the cassette 10 is removed and an empty cassette 10 is placed in front of the conveyor assembly 8 to replace it.

It will be seen that the group G of stacks S move along the conveyor assembly 8 and into the input unit 10 continuously. The conveyor assembly 8 is operating under instructions from a controller (not shown) to receive groups G of stacks S from the elevator 7 and to move the groups G into the input unit 10 at the same time that the printer, by-pass transport and buffer assemblies 20, 21 and 5, respectively, are continuously operating without interruption. Even when the input unit or cassette 10 is removed by an operator and replaced with an empty one, the groups G of stacks S continue to move without interruption.

It will thus be seen that the present invention provides an improved feeding mechanism in which the operation is continuous without interruption, in which the sheet stacking and stack processing operations do not interfere with the printing operation, in which the sheet printing and stack handling operations occur simultaneously without operation, and which is simple and inexpensive to use, maintain and manufacture.

As many and varied modifications of the subject matter of this invention will become apparent to those skilled in the art from the detailed description given hereinabove, it will be understood that the present invention is limited only as provided in the claims appended hereto.

The embodiments of the invention in which are exclusive property or privilege is claimed are defined as follows

1. A sheet handling mechanism comprising sheet feeding assembly and a set stacker assembly, said set stacker assembly comprising an elevator, said sheet feeding assembly comprising means for feeding sheets, means for accumulating said sheets into a stack, means for depositing a stack of sheets onto said elevator, means for accumulating said stack of sheets on said elevator in an offset relationship to each other to form a group of offset stacks, a conveyor assembly for moving said group of stacks from said elevator into an input unit, and a buffer station interposed between said feeding assembly and set stacker assembly, said buffer station having means for moving said stacks to said set stacker assembly.

2. A mechanism as set forth in claim 1 wherein said sheet feeding assembly comprise means for printing said sheets on a continuous web with said sheets in side by side relationship and one behind the other relationship.

3. A mechanism as set forth in claim 2 wherein a cutter assembly is provided to slit the continuous web lengthwise between the printed sheets and to cut the continuous web transversely between the printed sheets to form individual printed sheets.

4. A mechanism as set forth in claim 3 where a sequencer assembly is provided in which the individual printed sheets are sequenced one after the other.

5. A mechanism as set forth in claim 4 wherein a plurality of buffer stations are interposed between said sequencer assembly and said set stacker assembly.

6. A mechanism as set forth in claim 5 wherein said means for accumulating said stacks in offset relationship comprise means for moving said elevator back and forth while the stacks are being deposited thereon.

7. A mechanism as set forth in claim 6, wherein said elevator is lowered after a stack is deposited thereon.

8. A mechanism as set forth in claim 7 wherein said elevator is raised after a group of stacks is removed therefrom to empty it.

9. A mechanism as set forth in claim 8 wherein the buffer stations continue to operate when the elevator is emptied and raised.

10. A mechanism as set forth in claim 9 wherein a main conveyor assembly is provided between the said elevator and the said input unit whereby the group of stacks are moved by said main conveyor assembly from the elevator to a position adjacent the input unit.

11. A mechanism as set forth in claim 10 in which said input unit is at right angles to said main conveyor assembly and wherein an auxiliary conveyor is provided to move the group of stacks into said input unit.

12. A mechanism as set forth in claim 1 in which said sheet feeding assembly comprises means for printing individual printed sheets.

13. A mechanism as set forth in claim 12 wherein said individual printed sheets are moved onto said buffer station and to said set stacker assembly and wherein said set stacker assembly has means to accumulate said sheets into stacks.

14. A mechanism as set forth in claim 13 wherein a plurality of buffer stations are interposed between the printing assembly and said set stacker assembly.

15. A mechanism as set forth in claim 14 wherein means are provided to move the elevator back and forth in order to permit stacks to be accumulated on the elevator in offset relationship to each other to form a group of offset stacks.

16. A mechanism as set forth in claim 15, wherein means are provided to remove the group of stacks from the elevator to empty it and to deposit said group of stacks on said conveyor assembly and wherein the group of stacks are moved by said conveyor assembly into said input unit.

17. A mechanism as set forth in claim 16, wherein said input unit is in line with said conveyor assembly.

18. A mechanism as set forth in claim 17 wherein the buffer stations continue to operate when the elevator is emptied and raised.
